(19) United States
(12) Patent Application Publication
(10) Pub. No.: US 2021/0171150 A1
(43) Pub. Date: Jun. 10, 2021

(54) STEM FOLDABLE LATERALLY INSTANTEOUSLY ABOUT A VERTICAL OR NEAR-VERTICAL AXIS FOR BICYCLE OR CYCLE VEICHLE, ALLOWING STORAGE/TRANSPORATION/PARKING AND COMPRISING AN ANTI-THEFT SYSTEM

(71) Applicant: FRANCK JEAN SAVARD, SAINT MARTIN DE RE (FR)

(72) Inventor: FRANCK JEAN SAVARD, SAINT MARTIN DE RE (FR)

(21) Appl. No.: 16/771,603

(22) PCT Filed: Dec. 10, 2018
(86) PCT No.: PCT/FR2018/000266

§ 371 Date: Jun. 10, 2020

(30) Foreign Application Priority Data
Dec. 11, 2017 (FR) 17/01296

(51) Int. Cl. B62K 21/12; B62K 21/24

(52) U.S. Cl. CPC B62K 21/12; B62K 15/00; B62K 21/24

(57) ABSTRACT

A stem that can be folded laterally instantaneously about a vertical or near-vertical axis for a bicycle that allows storage/transportation/parking and constituting an anti-theft system. The width of the bicycle is minimized at the handlebar and optionally makes it un-rideable. The foldable stem, supporting a handlebar, that instantaneously folds the handlebar along the bicycle, and is optionally ergonomically adjustable. The foldable stem includes a stem body secured in a hyperstatic manner by an optionally quick-release tightener to a steering pivot. The stem body directly or indirectly supporting at least one substantially vertical rotation bearing on which the stem arm can oscillate. The handlebar stem simplifies and optionally protects the storage, transport and parking of the bicycle.

### RELATED APPLICATIONS

This application is a § 371 application from PCT/FR2018/000266 filed Dec. 10, 2018, which claims priority from French Patent Application No. 17 01296 filed Dec. 11, 2017, each of which is herein incorporated by reference in its entirety.

### FIELD OF THE INVENTION

For bicycle (cycle vehicles in general), stem that can be folded laterally instantaneously about a vertical or near-vertical axis, and allowing storage/transportation/parking and also constituting a possible anti-theft system.

### BACKGROUND OF THE INVENTION

Regardless of whether the stems are of the quill type (urban cycles) or threadless type (sports cycles), existing instantaneous storage/transport stems (that support the handlebar) pivot coaxially with the steering axis of the front fork, which does not optimize the desired reduction in width and/or simplification of manufacturing (tight machining tolerances and dimension chain!) and makes the insertion of an antitheft system complex and expensive, with a key that often disturbs the upper part of the stem, that hinders placement of an accessory (for example smartphone) above the stem.

### OBJECT AND SUMMARY OF THE INVENTION

The problem solved by the invention is to minimize the width of the bicycle at the handlebar when it is desired to store it or to transport it or to park it, and/or to simplify manufacturing; and optionally to make it unrideable by separation from the steering and/or offset from the front wheel whenever required, by means of an antitheft key located on the side or on the front of the stem, which leaves the space above the stem perfectly free, that can thus also hold an accessory such as a smartphone, cyclometer, heart frequency meter, camera, etc., either directly or using an interface plate.

To achieve this, the invention is characterized by a foldable stem, supporting a handlebar, and that enables instantaneous folding down of said handlebar along the bicycle, optionally said stem is ergonomically adjustable and comprises: a fixed stem made secured in a hyperstatic manner by an optionally quick-release tightening means to a steering pivot (front fork), said stem body directly or indirectly supporting at least one rotation bearing on which a stem arm can oscillate whenever required and when necessary; said bearing being positioned to make a stem folding axis that is perfectly distinct from the axis of said steering pivot, while remaining parallel or nearly parallel to it, in other words almost vertical in a normal use position of the bicycle.

According to particular embodiments, and assuming that the bicycle is in a situation in which its two wheels are in line:
The stem folding axis is placed to be lateral to the longitudinal vertical median plane of the bicycle, the rotation axis of the cylinder of the antitheft lock is preferably horizontally perpendicular to said folding axis of the stem; said rotation axis of said cylinder is coaxial, with a straight core supporting two bearing screws that enable folding of the stem, and a left core supporting the pin that locks the stem arm oscillating around said folding axis of the stem when said arm is in the normal use position; a connecting means enables the cylinder of the antitheft lock to drive said locking pin into the hole provided for it in the stem arm; it is clear that in this embodiment, said folding axis can be significantly inclined from the vertical, either forwards or backwards, so that tightening screws of said cores can be used to adjust the height and depth of the handlebar if necessary.
The folding axis of the stem is placed in the longitudinal vertical median plane of the bicycle, in front of the steering pivot; the rotation axis of the cylinder of the antitheft lock is preferably perpendicular to said stem folding axis and in said median plane; once again, a connecting means enables the cylinder of the antitheft lock to drive said locking pin into the hole provided for it in the stem arm.
Since the antitheft locking key is placed on the side of or in front of the stem, a clear space is available above the stem arm to hold or to install an accessory such as a smartphone or an odometer, etc., either directly or making use of an interface plate.
The stem according to the invention may by a threadless sports type or a quill urban type; advantageously, when the quill type is chosen, the invention preferably includes the provision of a fast height adjusting and locking means on said stem in which said stem quill slides in the pivot of the front wheel fork, thus enabling excellent ergonomics.

### BRIEF DESCRIPTION OF THE DRAWINGS

The appended drawings illustrate the invention.

FIG. 1 represents a rear right upper ¾ view of a stem according to the invention, that is particularly ergonomic;

FIG. 2 represents a view similar to FIG. 1, in the storage or transport or parking situation, the stem arm being turned to the right;

FIG. 3 represents a sectional view of FIG. 1 without the smartphone;

FIG. 4 represents the stem in the previous views, in fact with the stem arm inclined downwards, to lower and retract the handlebar for a short cyclist; the locking lever of the fork pivot bevel is raised which authorizes sliding of the stem quill in the fork pivot, thus allowing a different setting of the handlebar height.

FIG. 5 represents the stem in the previous views, in fact with the stem arm inclined upwards, to raise and to a certain extent (the maximum advance being obtained when the articulated stem arm is horizontal) to advance the handlebar for a tall cyclist;

FIG. 6 represents the previous stem without its different body parts and cores to make the internal mechanical elements of the stem illustrated above visible;

FIGS. 7, 8 and 9 represent the stem described above, in the three cardinal planes in the situation in which the cyclist is riding;

FIG. 10 represents a front right upper ¾ view of a stem according to the invention of the threadless type, with an antitheft key on the front of said stem in the normal situation in which the bicycle is in use;

FIG. 11 represents the stem in FIG. 10 but in a view similar to FIG. 2, in other words in the storage or transport or parking situation, the stem arm being turned to the right; and

FIG. 12 represents the previous stem without its different body parts and accessory supports to make the internal mechanical elements of the stem illustrated immediately above visible.

### DETAILED DESCRIPTION OF THE EMBODIMENTS

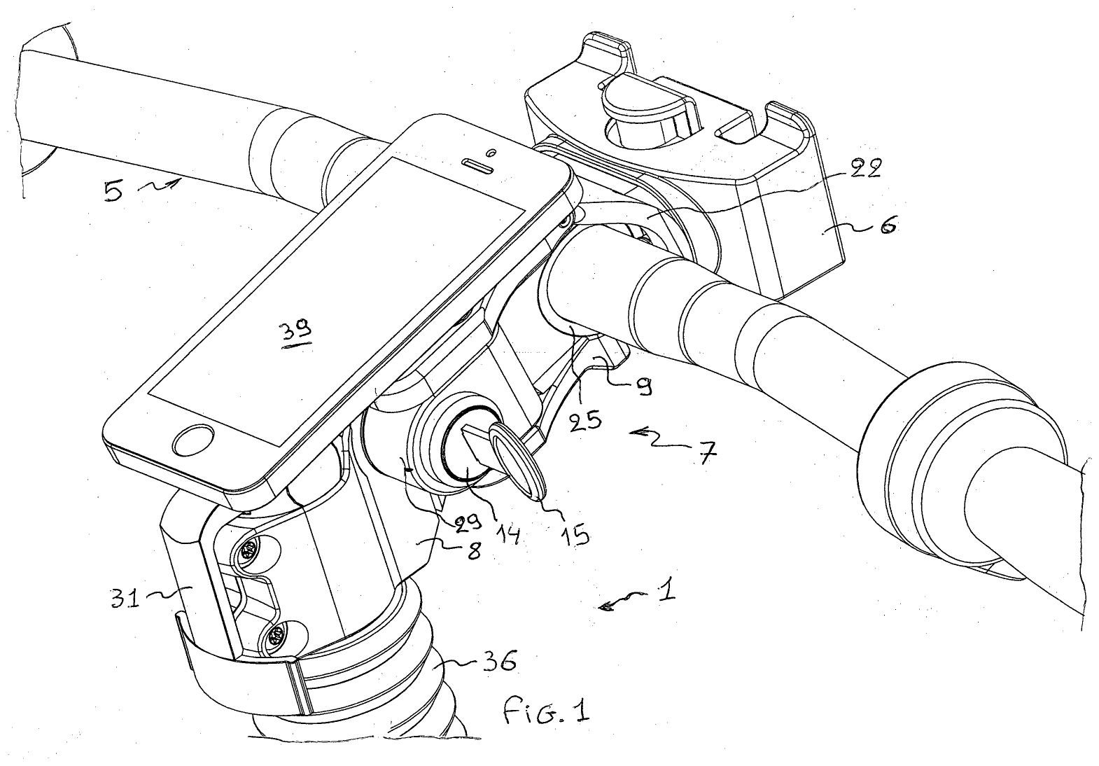

The stem according to the invention is of the quill type with an antitheft key on the right side of the stem in the normal situation in which the bicycle is in use, as shown in FIG. 1. In particular, the stem holds accessories, specifically a smartphone and a fast basket attachment support. The key of the antitheft lock can be removed when the stem arm is locked.

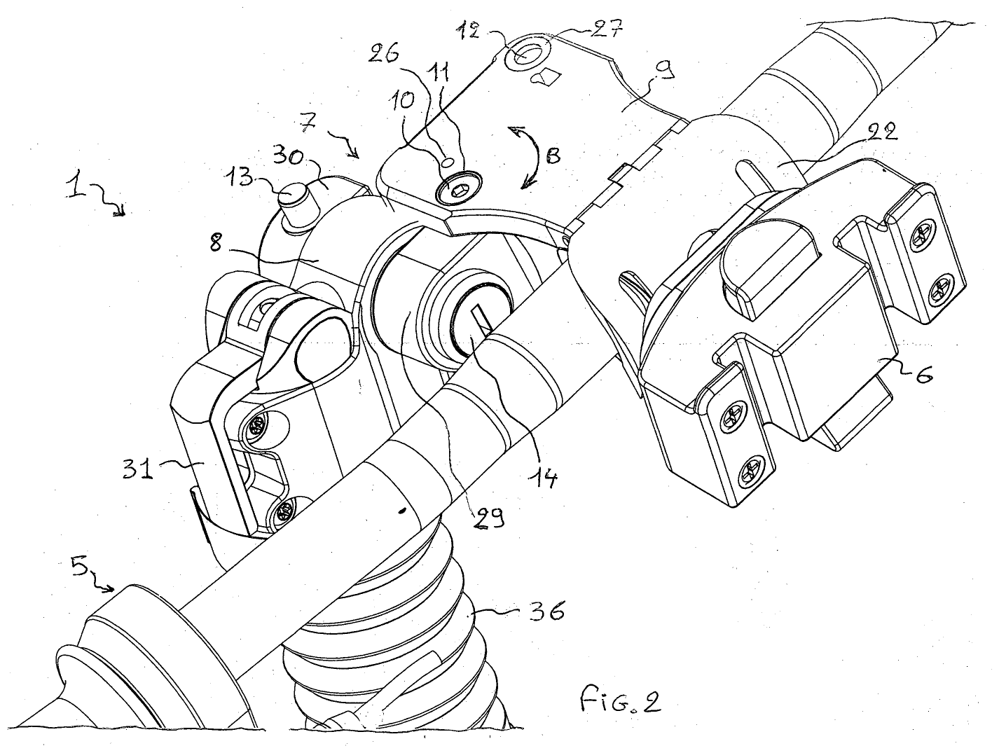

Since the locking pin is projecting in the storage or transport or parking situation as shown in FIG. 2, the key can be removed and the handlebar turning by itself making the bicycle un-rideable.

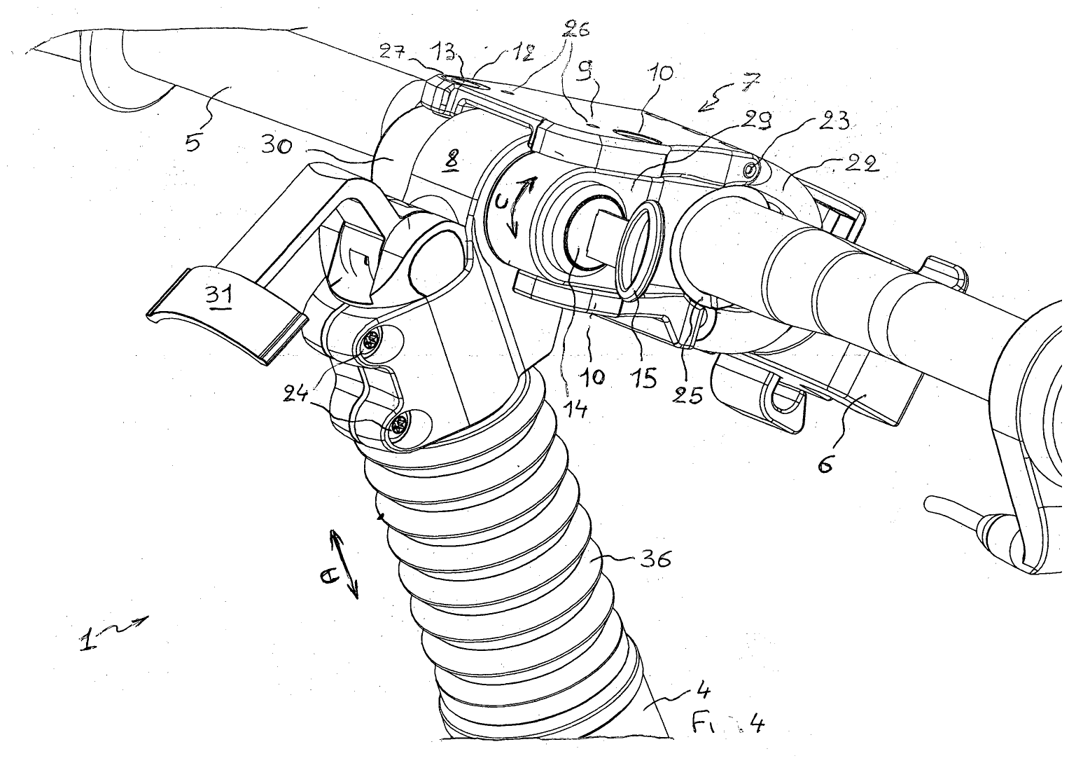

FIG. 4 represents the stem in the previous views, in fact with the stem arm inclined downwards, to lower and retract the handlebar for a short cyclist;

The locking lever of the fork pivot bevel is raised, as shown in FIG. 4, which authorizes sliding of the stem quill in the fork pivot, thus allowing a different setting of the handlebar height.

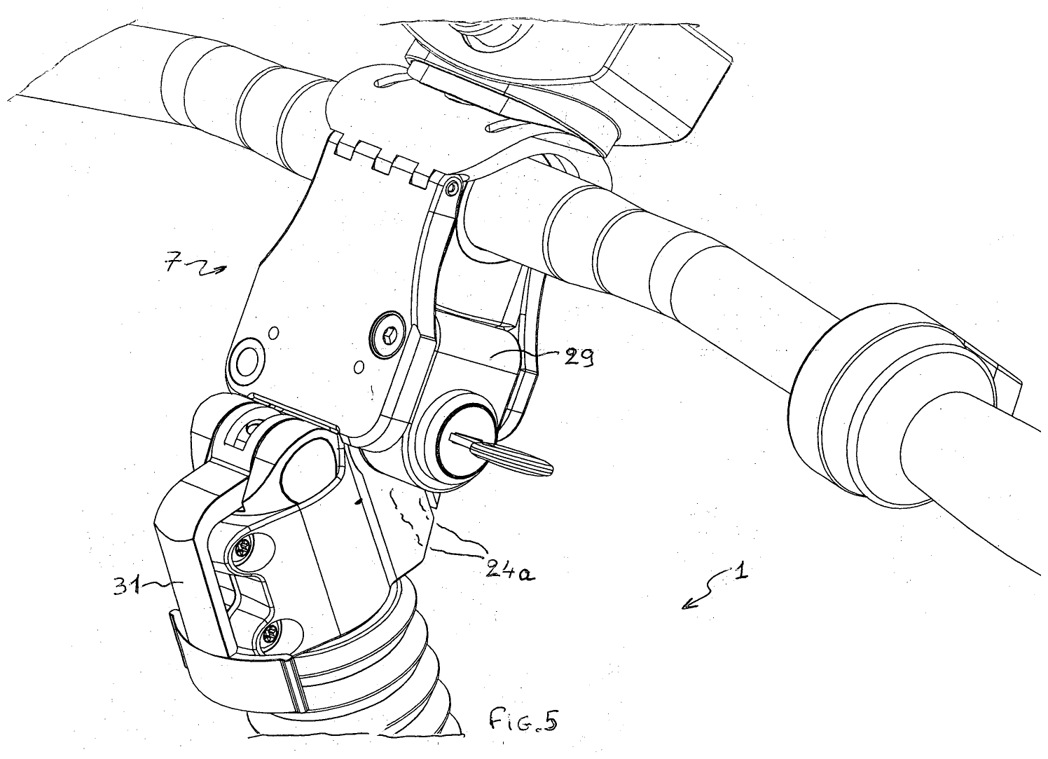

The locking level of the fork pivot bevel is lowered, as shown in FIG. 5, which blocks sliding of the stem quill in the fork pivot, thus allowing use of the bicycle.

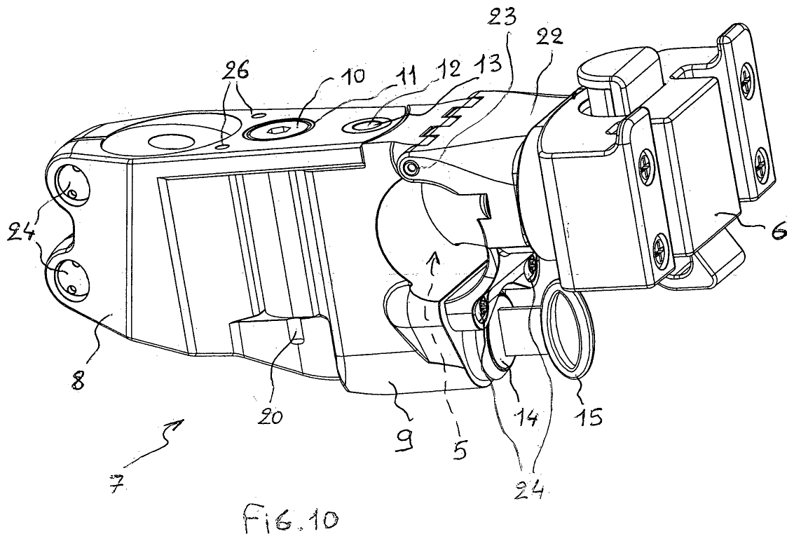

The stem according to the invention is of the threadless type with an antitheft key on the front of said stem in the normal situation in which the bicycle is in use, as shown in FIG. 10. The antitheft lock key can be removed when the stem arm has been locked.

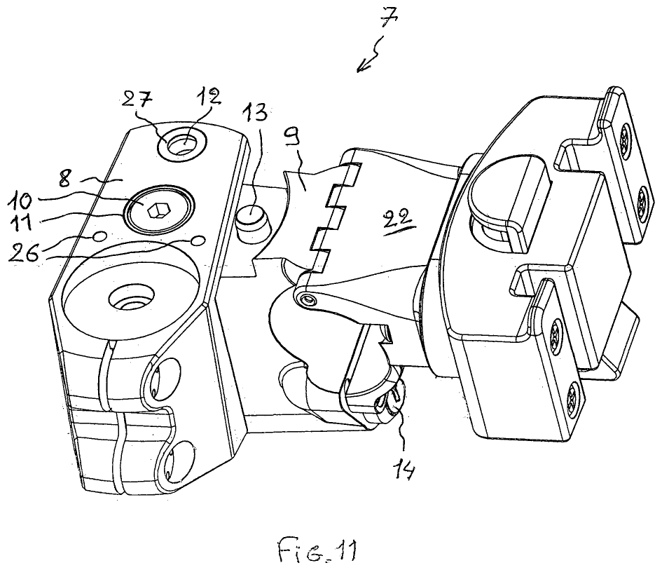

Since the locking pin is projecting in the storage or transport or parking situation as shown in FIG. 11, the key can be removed and the handlebar having become partially or completely blocked to the right (embodiment selected for the stem body), the bicycle is un-rideable.

With reference to these drawings, a bicycle (1) equipped with a foldable stem (7) comprises a body (8) fixed to the fork pivot (3), a stem arm (9) oscillates on this body (8) making use of at least one bearing screw (10), that forms a rotation axis perfectly distinct from the fork pivot (3) and that is substantially vertical, so that the handlebar (5) can fold down substantially horizontally along the bicycle (1).

A blocking means (13), preferably associated with an antitheft lock (14) with key (15), solidarizes and therefore immobilizes said stem arm (9) with the body (8) so that the bicycle can be used normally; the key (15) can then be removed; said locking means (13) controlled by the key (15) can release said locking means (13) which separates the locking arm (9) facing the body (8), thus making the bicycle unrideable, since the key (15) has been removed.

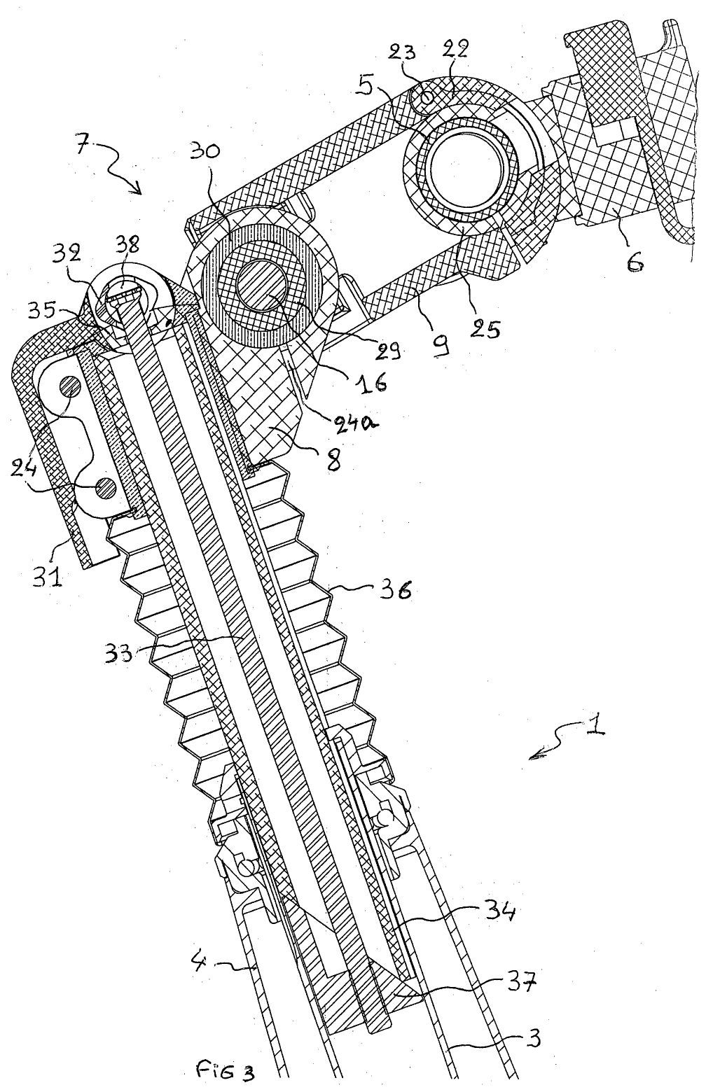

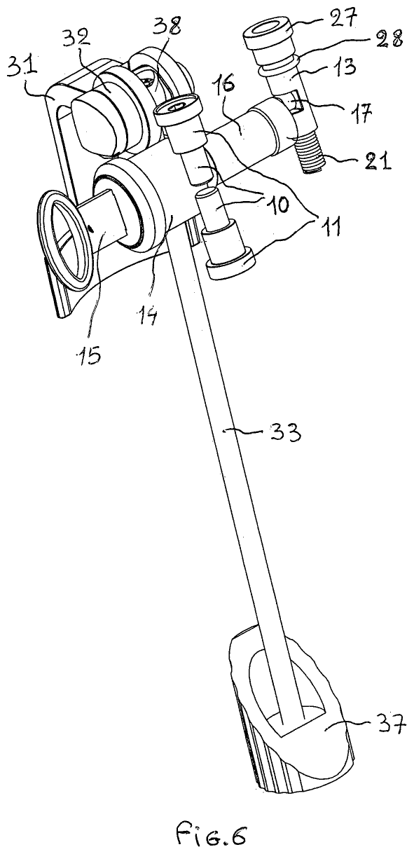

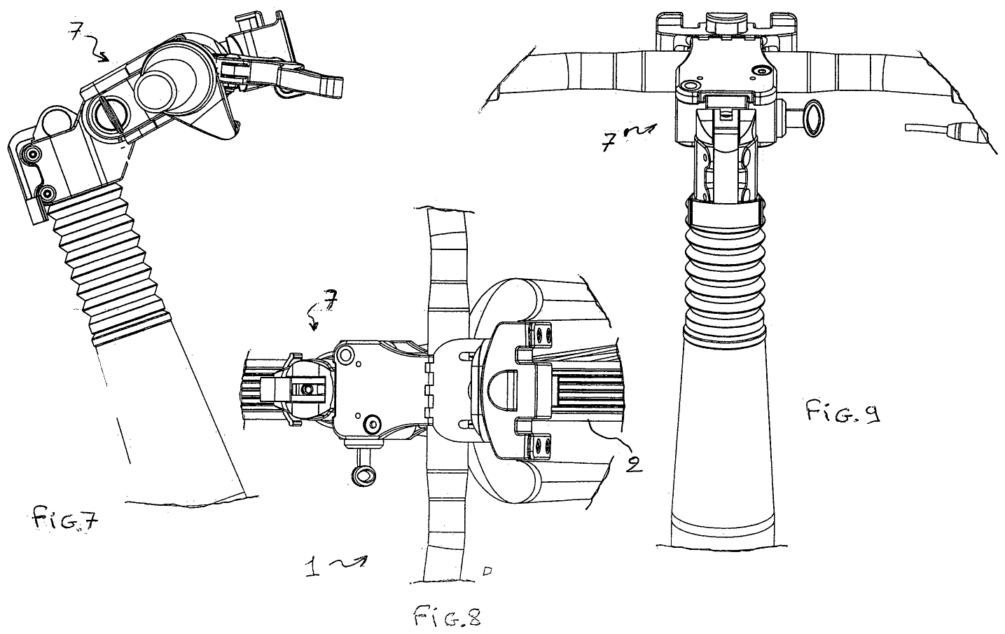

According to a first particular embodiment, intended more specifically for an urban type bicycle illustrated on FIGS. 1 to 9, the stem (7) is of the quill type (34) that slides in the pivot (3) of the fork of the front wheel (2), said quill after the stem (7) has been adjusted to the required height is made hyperstatic with said pivot (3) by tightening the screw (33) that applies tension on the bevel nut (37) that moves out of line and blocks sliding of the quill (7) on the pivot (3).

To facilitate the ease and speed of adjustment, a lever (31) acts through a cam (32) that cooperates with a pad (35) on a cylinder (38) with a radial penetration that holds the head of said screw (33), increasing or reducing the tension applied on the screw (33) by maneuvering said lever (31). A decorative and protective bellows (36) is inserted between the steering column (4) of the bicycle (1) and the stem (7). Said quill (34) is fixed (single-piece, tightened by screw, force fitted, welding, etc.) onto the body (8) of the stem (7).

The body (8) is provided with a collar in its front part that tightens a left core (30) coaxial with said collar by means of screws (24), this core (30) carries the locking means (13) that in this case is a pin (13) protected by an O-ring (28). These tightening screws (24) release the tightness of said collar and therefore incline the stem arm (9) whenever required before retightening.

Another core (29) coaxial with the collar of the body (8) and to the right of the collar, acts as a support for the screws (10) that form rotation bearings of the stem arm (9), that clearly represents the concept of folding the stem (7); preferably to make the oscillating rotation of the stem arm (9) reliable, shouldered spacers (11) for example made of brass, are inserted between the screws (10) and the core (29).

The lock (14) is housed in the core (29) coaxial with the collar of the body (8) and on the right side of the body (8), and consequently is also coaxial with the core (29); the cylinder of the lock (29) actuated by the key (15) drives a transmission shaft that has an eccentric pin (17) at its left end, said pin (17) acts like a cam that raises or lowers the pin (13), locking or releasing the stem arm (9) at will and depending on requirements.

For reliability reasons, the hole (12) in the stem arm (9) will be in a sleeve formed by a shouldered ring (27) made for example from hardened steel.

In order to reduce clearances between the pin (13) that will be as long as possible and perfectly adjusted to slide in the core (30), and the ring (27), they will have conjugate tapered shapes that under the pressure of a spring (21) pushing under the pin (13), the spot facing forming the housing for the pin (17) contributes to cancelling parasite clearances.

Advantageously, the stem arms (9) will be provided with attachment means such as at least one threaded hole (26) to fix an accessory, in this case a smartphone (39), either directly or using an interface plate.

Also advantageously, the half-collar (22) that tightens the handlebar (5) either directly or through a fixing ring (25), will be provided with an attachment means, for example for a basket support (6) in this case, or a light.

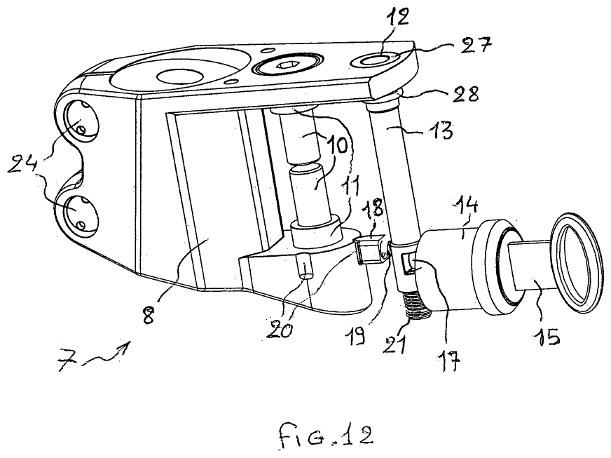

According to a second particular embodiment, and intended more particularly for a sports type bicycle, illustrated by FIGS. 10 to 12, the stem (7) is of the threadless type.

In this case directly, the stem body (8) acts as a support to the screws (10) that form rotation bearings for the stem arm (9) that also represents the concept of folding the stem (7); preferably, the shouldered spacers (11) are inserted between the screws (10) and the stem body (8).

The lock (14) is housed in the stem arm (9) and the rotation axis of its cylinder is in the longitudinal vertical median plane of said stem arm (9), and under the attachment half-collar (22) of the handlebar, preferably this half-collar (22) is fixed to the stem arm (9) by a hinge pin (23) and tightening screws (24); the cylinder of the lock (14) actuated by the key (15) drives an eccentric pin (17), said pin (17) acts like a cam that lifts or lowers the pin (13), locking or releasing the stem arm (9) at will and as necessary.

For reliability reasons, the hole (12) in the stem arm (9) will be in a sleeve formed by a shouldered ring (27) made for example from hardened steel.

In order to reduce clearances between the pin (13) that will be as long as possible and perfectly adjusted to slide in the stem arm (9), and the ring (27), they will have conjugate tapered shapes that under the pressure of a spring (21) pushing under the pin (13), the spot facing of which forming the housing for the pin (17) contributes to cancelling parasite clearances.

Preferably, indexing notches (20) are made in the body (8) so that an indexer (18) housed in the stem arm (9) and pressurized by a spring (19) can precisely position said stem arm (9) on the running and parking positions.

FIGS. 2 and 11 are very important concerning the kinematics and use process, since they show the bicycle (1) in the storage or transport situation. For parking; to put the stem into this situation folded at 90°, the user will firstly have turned the key (15), which provoked withdrawal of the locking pin (13) from the stem arm (9), and thus released the arm (9) was able to turn and become notched in a position at 90° towards the right. To actuate the antitheft position in this situation, the cyclist puts the key into its initial position which extends the pin (13) and said key (15) can then be removed. Thus projecting, the pin (13) makes it impossible to put the handlebar (5) back into its normal riding position, in fact said handlebar is loose or is blocked in an offset position so that it no longer acts normally on the fork (3) supporting the front wheel (2), which is dissuasive for a thief.

Not illustrated, the locking pin (13) could have a specific housing with or without an angular clearance in the locking arm (9) of the handlebar (5) when the handlebar is folded back laterally along the bicycle, replacing dissuasion against stealing the bicycle that was previously obtained by the handlebar (5) being unusable for steering, by a dissuasion in which the handlebar is locked in position with or without angular clearance, folded back along the bicycle.

Advantageously, the stem arms (9) will be provided with attachment means such as at least one threaded hole (26) to fix an accessory, in this case a smartphone (39), either directly or using an interface plate.

As an additional security, the attachment screws (24) could be antitheft screws, for example having a head that cooperates with a coded tool for screwing and especially for unscrewing said screws (24), further reinforcing dissuasion against theft of the bicycle.

It is clear that the function to lock/unlock the stem arm (9) using a lock (14) actuated by a key (15) can be implemented for example by a simple push button, replacing the lock (15) if the antitheft function is not required.

The solutions in the two example embodiments, with a key (15) on the side of the body (8) or on the front of the stem arm (9), can be mixed without going outside the framework of the invention.

Note that on FIGS. 2 and 4:
Arrow (A) indicates the possible fast height adjustment of the entire stem (7) and therefore the handlebar (5) using the lever (31).
Arrow (B) indicates the rotation movement that according to the invention enables the handlebar (5) to be folded back along the bicycle (1).
Arrow (C) indicates the tipping movement of the arm (9); this movement can be damped by an elastic means (not illustrated) interposed between the arm (9) and the body (8); or a movement made hyperstatic by tightening the screws (24a) that act on the part of the collar at the front end of the body (8).

### DESCRIPTION OF REFERENCE NUMBERS

1=Bicycle.
2=Front wheel
3=Front fork.
4=Frame steering column.
5=Handlebar with its brake and gear control equipment.
6=Possible basket and/or light support, preferably fixed to said collar (22).
7=Stem according to the invention, supporting the handlebar (5) and fixed to the pivot of the fork (3).
8=Stem body of the stem (7).
9=Stem arm of the stem (7).
10=Bearing screw retaining the arm (9) on the body (8), and coaxial with the spacers (11).
11=shouldered spacers enabling rotation of the arm (9) on the body (8), oscillating rotation in a substantially horizontal plane since it is perpendicular to the axis of the bearing screws (10).
12=Hole in the body (8) or the arm (9) depending on the chosen embodiment, and designed to hold the locking pin (13) with its conjugate shape.
13=Locking pin controlled by the lock (14) and its key (15), preferably tapered at its top end.
14=Antitheft lock making it impossible to reposition the handlebar (5) in a hyperstatic manner in the normal use position, when the bicycle is left in parking.
15=Locking key (14) that actuates the eccentric pin in rotation (17).
16=Possible spindle supporting the pin (17) and fixed to the cylinder of the lock (14).
17=Eccentric pin transforming the rotation movement of the cylinder of the lock (14) into a linear movement by which the pin (13) can be displaced, so that it can insert itself into the hole (12).
18=Indexer provoking notching of the riding and parking positions.
19=Pressure spring for the indexer (18).
20=Relief in which the indexer (18) fits.
21=Spring applying pressure on the pin (13) aimed at eliminating any residual clearance of said pin (13) in the hole (12).
22=Half-collar that enables the handlebar (5) to be tightened in contact with the stem arm (9).
23=Hinge pin of the half collar (22).
24=Tightening screw (optionally provided with an antitheft impression, requiring a very special coded tool).
25=Possible reducer of the handlebar (5).
26=Possible attachment means (for example threaded holes) for accessories interface (smartphone, cyclometer, camera, etc.).
27=Possible ring (preferably shouldered) containing the hole (12) and force fitted into the body (8) or the arm (9) and reinforcing the connection with the pin (13) because it is preferably made of treated hardened steel.
28=Sealing O-ring.
29=Core/axis that enables the tipping movement (C) of the arm (9) and also carrying bearing screws (10) and spacers (11)
30=Core/axis that cooperates coaxially with the core/axis (29), and therefore also enables the tipping movement (C) of the stem arm (9); it carries the pin (13).
31=Lever actuating the cam (32).
32=Cam applying tension on the screw (33).
33=Tension screw actuating the beveled nut (37) that, with the bevel of the quill (34) fixes the quill facing the pivot of the fork (3).
34=Quill secured in a hyperstatic manner to the body (8) and coaxial with the pivot of the fork (3) and provided with a bevel at its lower end.
35=Shouldered spacer fixed to the body (8) and acting as support for the cam of lever (31).
36=Decorative and protective bellows.
37=beveled nut.
38=Cylinder.
39=Accessory integrated into or added onto the stem arm (9).

The stem according to the invention is intended particularly for bicycles and cycles in general, in order to facilitate storage, transport and parking by reducing the overall width governed by the handlebar, while optionally providing dissuasion against theft, dissuasion based on the principle of reconstruction of a function enabling use of the bicycle and not on simple destruction of the antitheft means.

1-10. (canceled)

11. A stem for a bicycle, comprising a stem body and a stem arm, said stem body being secured in a hyperstatic manner to a steering pivot, said stem arm being articulated around a rotation axis defined by a rotation bearing presented by the stem body, said rotation axis being distinct from an axis of the steering pivot.

12. The stem of claim 11, wherein said rotation axis is parallel or nearly parallel to the axis of the steering pivot.

13. The stem of claim 11, wherein the rotation bearing is coaxial to an axis of rotation between a core and a fork maintaining the core.

14. The stem of claim 13, wherein said core comprises a locking device.

15. The stem of claim 14, wherein the locking device is a pin.

16. The stem of claim 15, wherein the stem arm comprises a housing specific to the locking pin, a shape of the pin being complementary to one of a ring inserted in said housing, to reduce clearances between the pin and the ring when the pin is compressed on the ring.

17. The stem of claim 16, further comprising a spring exercising a compression force on the pin towards the ring.

18. The stem of claim 16, wherein a cylinder lock drives the pin.

19. The stem of claim 18, wherein the cylinder lock is actuated by a key of a push button.

20. The stem of claim 13, wherein the fork is presented by the stem body.

21. The stem of claim 13, wherein the fork is presented by the stem arm.

22. The stem of claim 11, wherein the rotation bearing is placed on an articulated part of the stem body.

23. The stem of claim 22, wherein the articulated part corresponds to a second core in rotation with the stem body.

24. The stem of claim 23, wherein a rotation axis of the second core is perpendicular to the rotation axis of the rotation bearing.

25. The stem of claim 23, wherein the second core comprises a lock with a cylinder.

26. The stem of claim 25, wherein the cylinder of the lock, when actuated, drives a transmission shaft comprising an eccentric pin operating as a cam to raise or lower the pin to lock or release the stem arm.

27. The stem of claim 25, wherein the lock is actuated by a key or a push button.

28. The stem of claim 11, further comprising shouldered spacers inserted between the rotation bearing and the stem body.

29. The stem of claim 11, wherein a lock with a cylinder is housed in the stem arm, the cylinder of the lock driving an eccentric pin through an actuation of a key, said eccentric pin operating as a cam to raise or lower the pin to lock or release the stem arm.

30. The stem of claim 11, wherein indexing notches are made in the stem body so that an indexer housed in the stem arm and pressurized by a spring can position said stem arm on a running position or on a parking position.

31. A cycle comprising the stem of claim 11.
